(19) United States
(12) Patent Application Publication
(10) Pub. No.: US 2017/0350788 A1
(43) Pub. Date: Dec. 7, 2017

(54) Apparatus for distance and location of a stress attack on an entity

(71) Applicant: Kenneth Gerald Blemel, Albuquerque, NM (US)

(72) Inventors: Kenneth Gerald Blemel, Albuquerque, NM (US); Peter Andrew Blemel, Albuquerque, NM (US); Francis Edward Peter, Arvada, CO (US); Todd Francis Peterson, Albuquerque, NM (US)

(73) Assignee: Management Sciences, Inc., Albuquerque, NM (US)

(21) Appl. No.: 15/530,008

(22) Filed: Nov. 18, 2016

Related U.S. Application Data
(63) Continuation-in-part of application No. 14/187,225, filed on Feb. 21, 2014, now abandoned.
(60) Provisional application No. 61/850,655, filed on Feb. 21, 2013.

(51) Int. Cl. G01M 11/00; G01B 11/24

(52) U.S. Cl. CPC G01M 11/319; G01B 11/24

(57) ABSTRACT

A system that provides detection, annunciation, mitigation, and alleviation of stress attacks by executing algorithms based on measurement of intensity of light. The system determines to execute algorithms to take programmed action based on potential effects of a detected stress attack. The system can be used, for example, to determine the position of potential attacks to conduits that transport electricity, oil, gas, foodstuffs, water, people, and materials.

### CROSS-REFERENCE TO RELATED APPLICATIONS

This application is a continuation-in-part of utility patent application Ser. No. 14/187,225, filed 21 Feb. 2014, entitled, “An Apparatus for Distance and Location of a Stress Attack on an Entity,” which claimed the benefit of the filing of U.S. Provisional Patent Application Ser. No. 61/850,655, entitled “Apparatus for Distance Measurement Using Inductive Means,” filed on Feb. 21, 2013.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### TABLE US 00001 LIST OF REFERENCED DOCUMENTS

U.S. Pat. No. DOCUMENTS

| Pat. No. | Issue Date | Inventor |
|---|---|---|
| 6,160,126 | December 2000 | McMahon |
| 6,265,880 | July 2001 | Born el al. |
| 4,988,949 | January 1991 | Boenning et al. |
| 5,862,030 | January 1999 | Watkins, et al. |
| 6,249,230 | June 2001 | Baldwin et al. |
| 5,218,307 | June 1993 | Hiller |
| 6,868,357 | March 2005 | Furse, et. Al |
| 7,590,496 | September 2009 | Blemel |
| 7,356,444 | April 2008 | Blcmcl |
| 7,277,822 | October 2007 | Blemel |
| 7,974,815 | July 2011 | Blemel |
| 7,049,622 | May 2006 | Weiss |
| 7,763,009 | July 2010 | Weiss |
| 7,329,857 | February 2008 | Weiss |
| 6,965,709 | Nov 2005 | Weiss |
| 3,074,265 | January 1963 | Symons |
| 3,610,025 | October 1971 | Brunner |
| 5,078,432 | January 1992 | Seiter |
| 5,754,122 | May 1998 | Li et al. |
| 6,035,717 | March 2000 | Carodiskey |
| 6,265,880 | July 2011 | Born et al. |
| 6,392,551 | May 2002 | Dv Angelis |
| 6,487,518 | November 2002 | Miyazaki et al. |
| 6,512,444 | January 2003 | Morris et al. |
| 6,630,992 | October 2003 | Vobian et al. |
| 6,762,419 | July 2004 | Kranz |
| 5,862,030 | January 1999 | Watkins |
| 6,259,996 | July 2001 | Haun, et al. |
| 6,242,993 | June 2001 | Fleege, et al. |
| 6,230,109 | May 2001 | Miskimins, et al. |

### Non Patent Documents

12. George F. Luger “Artificial Intelligence Structures and Strategies for Complex Problem Solving,” Addison Wesley 2002
13. Finn V. Jensen “Bayesian Networks and Decision Graphs,” Springer-Verlag, New York N.Y., 2001
14. Eugene Charniak, “Bayesian Networks without Tears,” AI Magazine 1991
15. Edward A. Bender, “Mathematical Methods in Artificial Intelligence,” IEEE 1996
16. C. Stern, M. Lee, “An Automated Model Calibration System Based on a New Method for Localized Component Calibration,” Proceedings of ICALEPCS'99, Trieste, IT
17. C. Stern, G. Luger, “Integrated Model-based Diagnosis and Control Automation,” Intelligent Ship Symposium III, Philadelphia Pa., June 14-15, '99, ASNE Press: Philadelphia Pa.
18. J. Kaipio and E. Somersalo, “Statistical and Computational Inverse Problems,” Vol 160, Applied Mathematical Sciences, Springer, 2004.
19. G. A. Seber and C. J. Wild, “Nonlinear Regression,” Wiley, Hoboken, 2003.
20. H. T. Banks, Zackary R. Kenz, and W. Clayton Thompson, “A review of selected techniques in inverse problem nonparametric probability distribution estimation,” CRSC-TR12-13, North Carolina State University, May 2012; J. Inverse and Ill-Posed Problems.
21. A. Mallet, “A maximum likelihood estimation method for random coefficient regression models,” Biometrika, 73:3 (1986), pgs 645-656.
22. M. Bartur, “Automatic Detection of Optical ‘Faults’ in Communications Networks,” March 2013, Optics and Photonics Journal, pp 179-182.

### Description of Terms

The following terminologies are hereby defined so as not to have ambiguity of what a terminology refers to.

The term “axially” means lengthwise from end to end (as in axle of a car).

The term “radially” means exiting or entering from an edge.

The term “transmitting axially” means from an end point (as in axle of a car.)

Select a control algorithm—the source could be non-volatile memory or other location in the instrumentation or from a cloud location.

The term “autonomous” means capable of operating under self-control.

The term “threshold signal” is defined as a metric that if exceeded causes an action. The threshold could be stated as greater than or less than a certain reference value.

An unsafe condition precedes, at least momentarily, an unsafe event.

The term “map coordinates,” is defined as data that identify a location with reference to a Cartesian coordinate system.

The terms “photodetector” and “detector,” are used interchangeably to define a device that produces a data indicative of the intensity of light when exposed to photons.

The terms “translucent material”, “translucent media”, “translucent substance,” and “optical substance,” are used interchangeably.

The terms “angstrom” and “nanometer” are used interchangeably herein.

The terms “waveguide,” “optical waveguide,” and “light guide” indicate ability to guide light axially. The associated shape may be straight or curvilinear.

The terms “distance” and “length,” are used interchangeably herein.

The term “naturally fluorescent” refers a material that exhibits fluorescence at a certain wavelength when exposed to certain photons. For example, pure polyethylene exhibits 700 angstrom fluorescence when exposed to 400 angstrom ultraviolet rays.

The term “co-doped,” refers a material compounded with a substance that fluoresces at a certain wavelength when exposed to certain photons. For example, a glass strand compounded with aniline dye that exhibits 700 angstrom fluorescence when exposed to 400 angstrom ultraviolet rays.

The term “receptor” t refers to a length of translucent media that conducts induced light axially and emits light radially.

The term “emitter” refers to a length of translucent media that conducts stimulating light axially and emits stimulating light radially into a receptor.

The term “sensor” refers to elongated devices that contain a configuration of emitter(s) made with an elongated translucent substance that conduct stimulating light and receptor(s) made with a substance that produce induced light flux caused by the stimulating light. The sensor can be disposed proximal to a conduit to serve purpose to provide curvilinear distance measurement data when communicating with one or more photodetectors.

The term “side emitting property” means having areas along the length of an emitter that permit light flow axially in a portion or all off the entire axial surface.

The term “side-receiving property” means having areas along the length of a receptor that permit light flow axially into a portion of the entire axial surface.

The terms “side-receiving” and “side-collecting” are used interchangeably herein.

The term “light source” includes, but is not limited to rays of sunlight, laser light, and Light Emitting Diode (LED) passing through a mask or collimator with a linear (straight or curved) slit, aperture, or opening; or combinations thereof.

The term “branches” means divergences extending from along the sensor.

The terms “stress attack” and “stressor” means, but is not limited to, abrasion, vibration, shock, incisions, stress forces, chemicals, and heat.

The terms, “transform” “inverse transform” and “Bayesian transform” used herein to define the relationship of data tuples such as length obtained by physical measurements of intensity of light flux.

The term “inverse square law” in this context refers to the transform FX (formulated by Sir Isaac Newton) that defines how light intensity per unit area (E) varies monotonically in inverse proportion to the square of the curvilinear distance (d) traveled by light rays within a translucent waveguide and the formulae for the transform and inverse transform F-1X would take light intensity E as input and return distance x.

Fx: E=1/d² F_{-1X}: d=\sqrt{1/E}

It is inherent in the square law relationship that the intensity of the induced light emission relates monotonically to the distance.

### BACKGROUND OF THE INVENTION

The present invention relates to the field of applied engineering, concerned with the application of technology for condition monitoring and prognostic health management to provide safety and enhanced key performance parameters, such as reliability and maintainability.

The present invention relates generally to an apparatus for enhancing the safety of systems that carry exclusively or as mixtures; electrical, optical, electromagnetic signals, fluids, gases, or solids by determining and locating stress attacks and stress factors (stressors) that cause deterioration and damage to the conduits. More particularly, it relates to instrumentation with a combination of passive translucent strands used in-situ for automated inspection periodically or in real time, using a stimulating light source in combination with a photodetector all controlled by an automated means such as a processor with algorithms that detect a change in signals indicating a stress attack and measure distance to the stress attack.

The present invention more specifically relates to devices that measure three-dimensional (3-D) curvilinear distance with a processor configured with an algorithm for calculating distance and inferring the cause of the stress by monitoring factors such as rate of the stress by monitoring factors such as rate of change and directionality as multiple strands are affected.

The present invention also relates to using probabilities produced by Frequentist and Bayesian algorithms to understand the nature of the stress attack, as well as the probability of potential consequential damage to entities proximal to a stress attack.

The present invention relates to using Bayesian inverse transforms that are based on previous data (priors) to accurately determine key factors such as the length of the receptor, location of a stress attack, or distance to damage of a conduit. This includes using inference reasoning such as, “If the length is less than the original length (the prior), the length is the distance and location to damage to the receptor and by inference, there is an 80 percent likelihood of damage to a nearby entity within the hour.”

The present invention also relates to using a table lookup, or solving equations to identify the location of stress attack damage to continuous or branched conduits.

The present invention relates to using photons of stimulating light from a light source, which, without limitation, can be a light emitting diode, laser, fluorescent, incandescent, and sunlight. The light from a light source can, at any mixture of frequency, amplitude, and power, include collimated light from a laser. The light can be continuous or pulsed.

In the June 2013 article, “Automatic Detection of Optical ‘Faults’ in Communications Networks,” (incorporated in its entirety by reference above), Bartur states: “Today there is no proven method for automated monitoring of the optical fiber cable plant in the aggregation and data center segments of private campus or public communications networks. Metrics at the higher network layers may identify that a problem exists, but they cannot quickly isolate the location of an optical fiber fault nor can they automatically trigger the immediate dispatch of repair technicians.

An apparatus and method for using mathematical inference and light rays to determine curvilinear distance is provided. The novel aspects of this invention are set forth with particularity in the drawings and appended claims. The invention itself, together with further objects and advantages thereof, may be more readily comprehended by reference to the following detailed description of presently preferred embodiments of the invention, taken in conjunction with the accompanying drawings. The medium used throughout the drawings are for example only.

This invention relates to an instrumented system for monitoring stress attack and collateral damage by using optical sensors and measuring length thereof in a curvilinear coordinate system. The instrumented system comprises: a source of stimulating light, translucent media that emit the stimulating light into co-doped translucent strands that conduct light to a photodetector that produces a data signal indicative of light properties.

Various embodiments of the invention are disclosed in the detailed description and accompanying drawings.

### DISCUSSION OF PRIOR ART

The following discussion presents limitations of prior art, or those aspects not covered by prior art, that are addressed by the present invention. For brevity, only the most significant limitations of each category of prior art are included.

The problem of the prior art is its complexity, inability to solve real-world problems, the need for bulky apparatus, and numerical processing of algorithms, which adds weight and increases cost.

Our search of patent databases discovered over two hundred U.S. patents that deal with detection of faults in electrical signals, detection of damage, and deterioration in operating equipment, electrical conductors, in electrical power systems, oil and gas distribution systems, along with patents of similar nature applied to deterioration and damage of pipelines, fiber optic networks and other conduits. Almost all of the said patents do not address detecting stressor attack or isolating the location of where the stress attack is taking place before damage, deterioration, and unsafe condition has occurred.

Prior art that teach single-ended sensing with processing signals of reflected waveforms to determine and locate damage to conduits is limited to un-branched conduits because complex branched conduits have distance ambiguities, since several branches will traverse the same reflected distance. Our web and patent searches found systems and apparatus and methods that employ collimated light from lasers and optical domain reflectometry analytics to compute distance to a fracture or termination in an optical-grade glass or plastic sensor to monitor temperature and pressure within conduits, as well as leaking liquids and gases from damaged conduits.

Our searches found no patents or applications that address unambiguously predicting, detecting, and locating stressor attacks with controls to pre-empt, ameliorate, or mitigate damage in complex systems with a single-ended device taught by the present invention because with other methods, the calculated distance could be more than one branch that has the same calculated distance giving an ambiguous result.

Our searches found there is currently nothing in wide use that utilizes measurement of length based on intensity of induced or collected light with an inverse transform based on the square law of light intensity versus distance light travels or other transform to compute distance to point of damage to conduits such as, but not limited to, electrical wiring harnesses, fiber optic cables, or hydraulic lines. Our searches found nothing is in wide use employing inductive light response and an inverse transform to accurately determine distance to point of damage on surface, in sheath, or within branched conduits using un-collimated light. Use of uncontained electrical signals is often dangerous and hazardous (especially when conduits carry flammable or explosive matter), yet currently nothing is in wide use that enables calculating distance damage by un-collimated light means.

Currently nothing is in wide use that teaches unambiguous distance calculation using measurements from a single-ended sensor to locate stressors that will cause damage, or have caused damage, to a conduit. In particular, there is nothing that teaches unambiguous distance calculation using measurements from a single-ended sensor to locate points where heat, strain, or other stressor is causing an unsafe condition in an electrical conduit before an open circuit, or a short circuit, or grounding of a circuit happens.

Patent searches in preparation of this application have not found prior art that provides a means for enabling inexpensive automated distance calculation for isolating the location of stressor attack and damage to equipment and conduits that do not rely on electricity means. Said searches have not found prior art that utilize induced illumination of a translucent media as a means for measuring distance for locating damage to the conduit insulation and, by implication, the conductor therein.

U.S. Pat. No. 4,988,949 by Boenning et al. is limited to teaching detecting a short circuit caused by mechanical damage (chafing) on electrical cables against grounded structures under constant monitoring. Boenning et al. does not teach locating the distance to the fault before the short Occurs.

Watkins patent U.S. Pat. No. 5,862,030 teaches an electrical safety device comprised of a sensor strip disposed in the insulation of a wire or in the insulation of a sheath enclosing a bundle of electrical conductors, where the sensor strip comprises a distributed conductive over-temperature sensing portion comprising an electrically conductive polymer having a positive temperature coefficient of resistivity which increases with temperature sufficient to result in a switching temperature. Watkins' patent does not teach a means to perform detection of mechanical damage without use of an electrically conductive sensor material. Watkins' patent does not teach detecting stressor attack, or use of optical measurements, or measuring distance to locate the point of heating.

Baldwin et al. (U.S. Pat. No. 6,249,230) discloses a ground fault detection system and ground fault detector. Baldwin does not teach means to identify the curvilinear distance to or location of ground faults.

Haun et al. (U.S. Pat. No. 6,259,996) and Fleege et al. (U.S. Pat. No. 6,242,993) teaches arc fault circuit breakers that act to interrupt in real time on detection of arcing electrical faults, but it may be too late to avert disaster. Haun et al. do not teach how to calculate curvilinear distance to the arcing electrical fault.

Patents dealing with diagnosing arc and electrical ground faults in electrical conduits have limitation because they do not assist detection and isolation of the location of a stress attack before the arc or ground fault problem occurs and do not assist repair people in locating the place of where the problem occurs in order to correct the situation and any damage caused. The present invention overcomes these limitations for two reasons. First, the present invention can detect conditions prior to when an arc fault or ground fault event occurs. Second, the present invention accomplishes measuring the curvilinear distance along the conduit by calculating the curvilinear distance with a simple inverse square law transform.

It is a limitation when prior art such as Hiller's U.S. Pat. No. 5,218,307 and Miskimins' U.S. Pat. No. 6,230,109 require manual intervention when inspecting electrical and conduits of hazardous materials for finding defects and failures. The present invention overcomes this limitation by using light conducted in a translucent strand laid on or in a conduit before damage occurs in combination with a photodetector further coupled to a controller comprised of a processor configured with means to send messages and means to execute actions to mitigate, ameliorate, control, or eliminate the stress attack.

Furse, et al. U.S. Pat. No. 6,868,357 teaches how to use a frequency domain reflectometry (FDR) in metal conduits to measure distance to an impedance after a short circuit or open circuit has happened. Furse et al. does not teach how to calculate distance to damage in non-metallic materials that surround and/or protect a conduit.

Blemel, U.S. Pat. Nos. 7,590,496, 7,356,444, 7,277,822, and 7,974,815 teach how to release a dye substance that is released from a hollow strand which a maintainer must find to locate points of damage. Blemel does not teach accurately calculating the curvilinear distance to the point of damage.

Weiss, U.S. Pat. No. 7,049,622 teaches using measurement of light intensity induced into a translucent sensor to measure distance to the surface of a fluid and distance to point of separation of immiscible fluids. Weiss but does not teach using light to measure length of the sensor receiving the induced light.

### Objects and Advantages

One object of the present invention is to provide means to detect and locate stress attack, and locate damage to components by measuring intensity of light induced within translucent media receptor induced by light rays entering from a proximal translucent media to calculate the length of the receptor, which, if less than a previously measured length, indicates where damage will likely occur to a conduit before the component integrity is compromised.

Another object of the present invention is to provide a single-ended sensor employing induced light in translucent media to eliminate ambiguity of which branch of a branched conduit is stressed, at risk, or is actually damaged by employing the present invention.

Another object of the present invention is to provide a means to eliminate ambiguity of which branch in a branched conduit is subject to stress attack, is at risk, or is actually damaged by employing the present invention

Another object of the present invention is to provide a means to sense and locate stress attack, stressors, and damage that does not depend on electricity to excite sensor material or read the sensor.

Another object of the present invention is to calculate curvilinear distance, which provides means to calculate the location of stressors and damage the stressors cause.

Another object of the present invention is to provide data to diagnose cause of damage including, but not limited to, mechanical stress (chafing), corrosion, and heat, with the advantage that the detection and diagnosis is prior to any damage to the system monitored or to systems in the vicinity.

Another object of the present invention is measuring the rate of stressor attack with the advantage of enabling pre-emptive actions through knowledge of the degree and speed of attack, and if the speed is slow enough, to take pre-emptive action prior to any damage.

Another object of the present invention is to annunciate stress attacks and information about the stressors and take programmed action that provides mitigation, melioration, alleviation, and prevention to reduce local and collateral damage by employing the present invention.

It is an advantage of the present invention that the sensor can be configured within a conduit, wrapped around a conduit, or it can be placed on or can be sleeved over a conduit. The present invention thus enhances and protects the existing insulating and protecting material while providing enhancements to current visual inspection techniques and also to inspection using non-visual measurement systems during operations, inspections, tests, and repairs. When embodied in, or added to, a branched interconnection system, system of conduits or pipeline, the invention provides a means for ready and accurate determination of location and degree of damage.

It is an advantage of the present invention that safety risks are avoided, because the present invention enables use of light to measure curvilinear distance avoiding the safety risks inherent in using electricity.

Accordingly, besides the objects and advantages described in the above paragraphs, several objects and advantages of the present invention are: (a) to provide a means for unattended surveillance and real time inspection of integrity of branched systems; (b) to provide accurate estimate of the curvilinear distance to location of damage so as to facilitate remedial action; (c) to provide a means to be pro-active by enabling and providing for early location identification of the sensor of the present invention before damage to the more important object in proximity; and (d) to provide information to maintenance and safety personnel where a situation exists that, left unattended, could lead to damage of components and disrupting the system.

### BRIEF DESCRIPTION OF THE DRAWINGS

FIG. 1 is a cutaway diagram of the interior of an exemplary embodiment constructed according to the present invention with a sensor made with an emitter having a central receptor core. When pumped by a light source, the axial distribution of the pumped light may be substantially constant along its length. Along the length of the emitter, the pumped light flows radially into the receptor (within the emitter) causing an intensity of induced light flux which is guided axially to a photodetector.

FIG. 2 is a cutaway diagram of the interior of an exemplary embodiment constructed according to the present invention. When pumped by a light source, the axial distribution of pumped light may be substantially constant along its length. The pumped light flows radially into a parallel and proximal receptor causing an intensity of induced light flux, which is guided to a photodetector.

FIG. 3 is an exploded view diagram of the sensor of FIG. 2

FIG. 4 is a perspective view of a sensor with six spaced-apart pairs of emitters and receptors.

FIG. 5 is a perspective view of three pairs of rectangular emitters in close proximity to three rectangular receptors.

FIG. 6 is a perspective diagram with a cutaway view of the interior of an exemplary embodiment of a sensor posited on a surface.

FIG. 7 is a perspective exploded view of an exemplary ribbonized multi-sensor constructed with six undamaged translucent receptors positioned proximal above six translucent emitters on an opaque material.

FIG. 8 is a perspective diagram which shows an exemplary cutaway diagram of a sensor constructed with six translucent receptors each with a pattern of opaque coating positioned proximal above six translucent emitters in an opaque material.

FIG. 9 is a perspective view of a translucent receptor surrounding proximal to a translucent emitter encased within an emitter; one receptor with a noble metal coating, one receptor with base metal coating, and one receptor with opaque water-soluble coating adjacent to a translucent emitter; all inside a sleeve of opaque material.

FIG. 10 is a perspective view of six rectangular receptors above a single flat translucent emitter.

FIG. 11 is a perspective view of a translucent emitter with a side-emitting feature constructed in accord with the present patent.

FIG. 12 is a perspective cutaway view which shows diagrammatically an emitter with inward reflecting coating emitting light flux through a side-emitting feature to a side-receiving feature of a proximal and parallel receptor.

FIG. 13 is a cutaway diagram of a sensor tree for the purpose of monitoring for stress attack on a trunk of a branched conduit. The sensor tree is comprised of a multiplicity of sensors with splitters that route the translucent strands at the root junctions.

FIG. 14 is a cutaway diagram of a sensor tree constructed of emitters constructed with a first translucent media and receptors constructed with strands of a second translucent media which shows how light flux diminishes at couplings and is amplified with optical amplifiers. The sensors comprising the sensor tree are depicted as operably coupled end to end disposed along a branched conduit.

FIG. 15 is a perspective view of an exemplary embodiment of a sensor with a translucent emitter proximal and parallel to a translucent receptor; the pair sheathed within an opaque material.

FIG. 16 is a diagram of how calculation of a length of a receptor is accomplished with a line graph produced with an inverse transform mapping light intensity measurement to length measurements during calibration.

### REFERENCE TO NUMERALS USED IN DRAWINGS

1 Conduit
2 Branches
3 Sensor
4 Side-Receiving Feature
5 Sensor Tree
6 Opaque Cladding
7 Side-Emitting Feature
8 Source of Stimulating Light
9 Induced Light Flux
10 Stimulating Light Flux
11 Light Reflecting Surface
12 Damage
13 Instrument
14 Optical Repeater
15 Coupling
16 Mounting Surface
17 Receptor
18 Graph
19 Emitter
20 Photodetector
21 Processor
22 Pattern of Opaque Coatings
23 First Translucent media
24 Second Translucent media
25 Translucent Media
26 Data Point
27 Splitter
28 Inward Reflecting Coating
29 Water Soluble Coating
30 Branched Conduit
31 Ultraviolet Light Source
32 Ultraviolet Rays
33 Signal
34 Controller

### DETAILED DESCRIPTION OF THE DRAWINGS

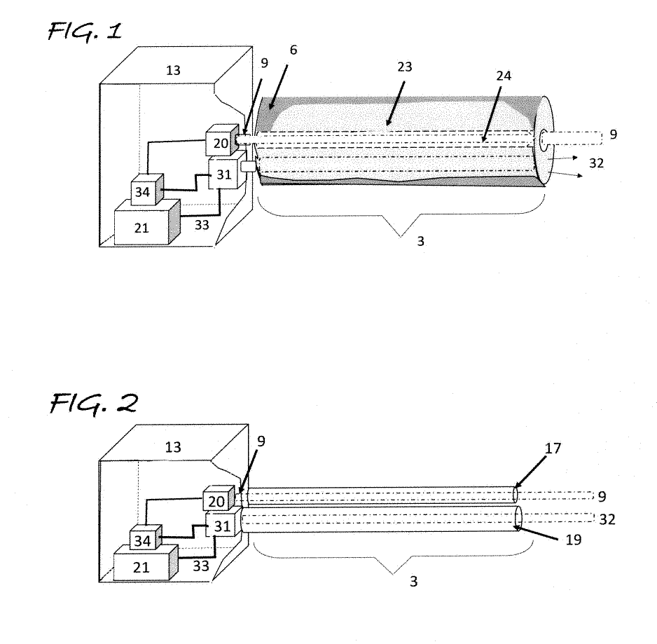

Referring now to FIG. 1 which is a cutaway perspective view of an embodiment according to the teaching herein. On the left is an instrument 13 comprising a processor 21 operably coupled to a controller 34 that operates a photodetector 20 and is also operably coupled to an ultraviolet light source 31.

Again referring to FIG. 1. To the right of the instrument 13 is a sensor 3 with opaque cladding 6 surrounding a first translucent media 23 having a core of a second translucent media 24. The opaque cladding 6 can be omitted if the sensor 3 is situated in a darkened place, such as buried in the ground.

Still referring to FIG. 1. When operated by the controller 34, the ultraviolet light source 31 produces stimulating light that enter the first translucent media 23 from the left end. The first translucent media 23 guides the ultraviolet rays 32 axially into substantially all of the length. A portion of the ultraviolet rays 32 escape radially into the inner second translucent media 24 causing an intensity of induced light flux 9 within that is guided axially to the photodetector 20 that outputs a signal 33 representative of the intensity of induced light flux 9 to the processor 21 which receives the signal 33 and computes the length of the second translucent media 24 with a look-up table or an inverse transform (which can be Bayesian or Frequentist) or interpolation of data points obtained during calibration, or by solving equations, or other appropriate algorithm that maps intensity of the induced light flux 9 to length of the second translucent media 24. The processor 21 then outputs a data indicative of the length

Referring now to FIG. 2, which is a cutaway perspective view depicting another embodiment of the present invention. On the left is an instrument 13 comprising a processor 21 operably coupled to a controller 34 that operates a photodetector 20 and an ultraviolet light source 31. The instrument 13 is operably coupled to the sensor 3. Note that an optional opaque cladding surrounding a translucent emitter 19 and a translucent receptor 17 is omitted in order to show the interior construction. The ultraviolet light source 31 produces an intensity of ultraviolet rays 32 that enter the left end of the translucent emitter 19 which guides the ultraviolet rays 32 axially. Due to refractions in the translucent media, a portion of the ultraviolet rays 32 escape radially into the receptor 17 causing a diffused intensity of induced light flux 9 within that is guided axially to the photodetector 20. The photodetector 20 outputs a signal 33 indicative of the intensity of induced light flux 9 it receives. The signal 33 is received by the processor 21. The processor 21 computes the length of the receptor 17 with a means that converts the signal 33 representative of the intensity of induced light flux 9 to length of the receptor 17. The processor 21 outputs a data indicative of the length of the receptor 17. The means can be a Bayesian transform, or a Frequentist transform, or interpolation of data points obtained during calibration, or by solving equations, or other appropriate algorithm.

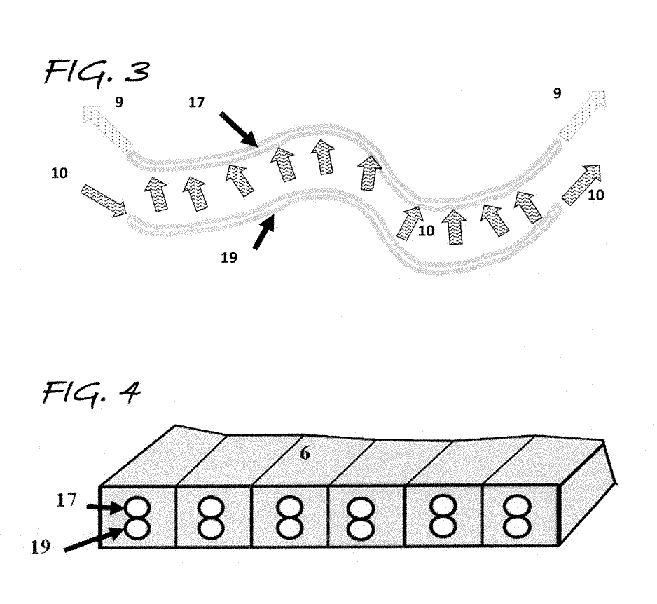

FIG. 3 is an explosion view diagram of the sensor of FIG. 2 showing stimulating light flux 10 from the translucent emitter 19 shining radially into the translucent receptor 17 causing an induced light flux 9. (An opaque cladding is omitted to show the interior of the sensor.

Referring now to FIG. 4 which is a perspective diagrammatic view of a two-layered embodiment having two layers of six pairs of translucent receptors 17 each vertically disposed above a translucent emitter 19 with the proximal surfaces touching so that light passes into the receptor 17. The six pairs are shown individually embedded in an opaque cladding 6 forming a ribbon configuration. The individual translucent receptors 17 and individual translucent emitters 19 can be made of any translucent media that does not significantly absorb the stimulating rays that induce flux in the receptors 17.

Still referring to FIG. 4, when the two-layered embodiment is coupled to instrument 13 (not shown) with a processor configured with a criteria that identifies a change in intensity of induced light in a few receptors 17 as a precursor to a stress attack causing an unsafe condition; whereas change in intensity of induced light of most of the receptors 17 is indicative of a stress attack causing an unsafe event. Furthermore, adjusting one or more of the precursor criteria in response to a changed condition of the sensor could result in a signal to a protection system or a change of the configuration of the system protected by the embodiment.

Referring now to FIG. 5, which is a perspective view of three rectangular translucent emitters 19 disposed parallel to three rectangular translucent receptors 17. The outer edges are depicted as opaque while the inner surfaces are depicted as translucent with a dotted line indicating that light passes between. The individual translucent receptors 17 and individual translucent emitters 19 can be made of any appropriate translucent media. An opaque cladding 6 encasing is shown on the outer surface.

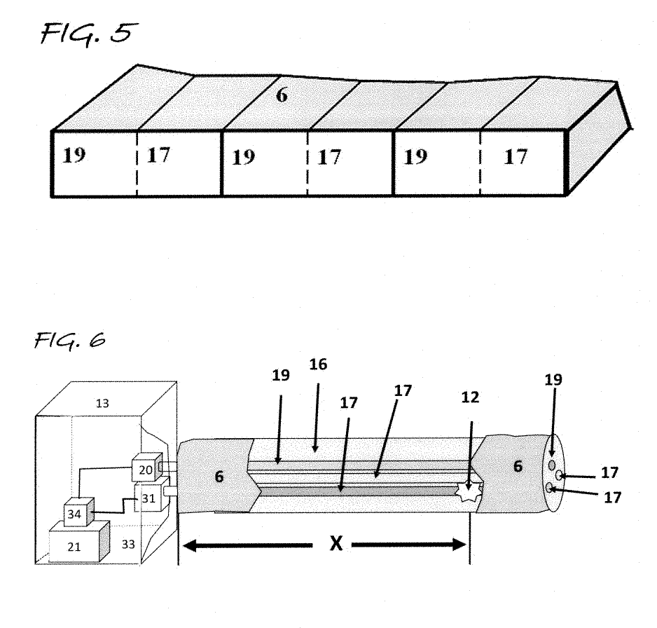

Referring now to FIG. 6, which is a cutaway diagram of an interior view of an embodiment of a sensor according to the present invention that is purposely drawn with a cutaway between the right and left ends of opaque cladding 6 to expose the interior construction. FIG. 6 is intended to illustrate how the cause of stress can be inferred by using different types of opaque cladding. The instrument 13 contains a processor 21 operably coupled to a controller 34 coupled to a source of ultraviolet light source 31 and a photodetector 20 which sends signal 33 indicative of the intensity of induced light flux. The ultraviolet light source 31 sends an intensity of ultraviolet light into a translucent emitter 19 that emits light radially into the length of two closely proximal translucent receptors 17 wherein one is unclad and the other is a receptor 17 with an opaque water soluble coating (not shown) Damage 12 caused by water has dissolved a water soluble coating 29 and changed the intensity of induced light received by the coupled photodetector 20. The processor 21 can be configured with a look-up table, or an inverse transform which can be Bayesian or Frequentist, or interpolation of data points obtained during calibration, or by solving equations, or other appropriate algorithm that calculates distance X measured from the coupling of photodetector 20 to the point of damage based on the change in intensity of light.

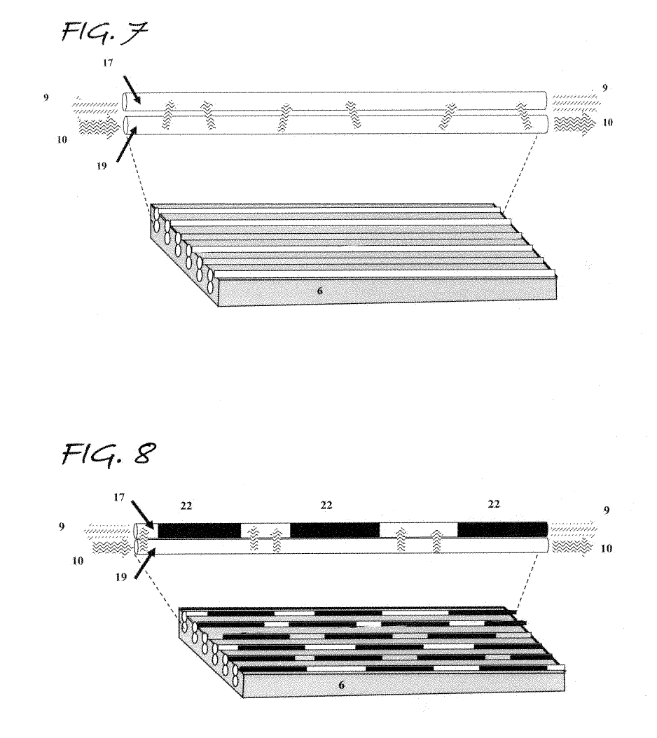

Referring now to FIG. 7, which shows a perspective view of an exemplary embodiment of ribbon construction with six translucent receptors 17 positioned immediately above six translucent emitters 19. The six sensors are encased in an opaque cladding 6, the upper surface of which is not shown in order to show the interior construction. The upper part of FIG. 7 is an explosion view where stimulating light flux 10 enters an emitter 19 and escapes radially into a receptor 17. Note that some stimulating light flux 10 flows from the right end of the emitter 19. Induced light flux 9 generated by the stimulating light flux 10 is guided in the receptor 17 and exits both ends.

Referring now to FIG. 8 which is a perspective diagram of an exemplary cutaway diagram of a sensor constructed with six translucent receptors 17 each made with a spaced-apart pattern of opaque coating 22 The six translucent receptors 17 are closely proximal disposed over the six translucent emitters 19 and are shown posited in an opaque cladding 6. (Note the upper surface of the cladding is not shown in order to expose the interior of the diagram.) The upper part of FIG. 8 is an exploded view where stimulating light flux 10 from a light source (not shown) enters emitter 19. The stimulating light flux 10 escapes radially from the emitter 19 into uncoated portions of the receptor 17. Induced light flux 9 generated by the stimulating light flux 10 is guided axially within the receptor 17 and exits both ends. Note that opaque cladding 6 above the translucent emitters 19 is omitted to show the interior construction and also note that the diameters of the emitters 19 and receptors 17 are shown with exaggerated diameter. It should be observed that the pattern of opaque coating 22 on portions of the receptors 17 makes the associated inverse transform potentially less accurate because light from the associated emitters 19 cannot be received along its length.

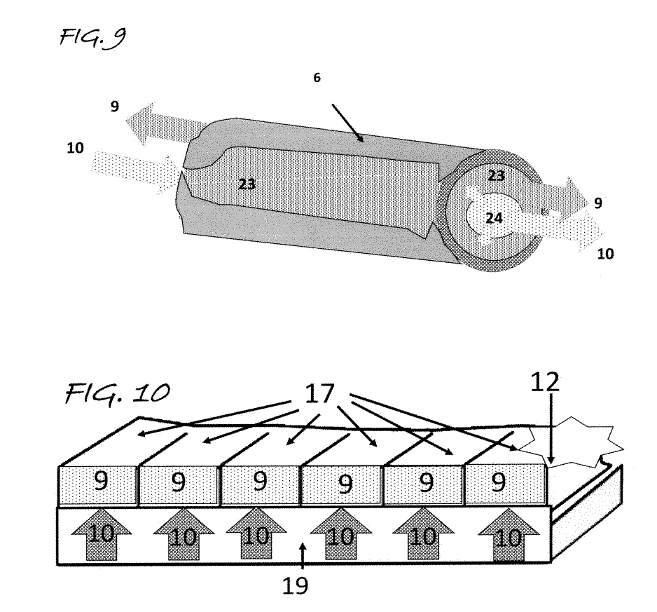

Referring now to FIG. 9, which is a perspective view of sensor constructed with an opaque cladding 6 encasing a naturally fluorescent or co-doped first translucent media 23 that surrounds a second translucent media 24 which does not fluoresce significantly when exposed to stimulating light flux 10. The stimulating light flux 10 entering on the left is shown guided axially and emitted radially from the second translucent media 24 into the first translucent media 23. The stimulating light flux on entering the first translucent media 23 causes an induced light intensity 9 that is guided axially in both axial directions.

Referring now to FIG. 10, which is a perspective diagram of an embodiment which can be used to infer the type and rate of stress. Six receptors 17 made with rectangular media are posited above a single translucent emitter 19 which emits stimulating light flux 10 into all six receptors 17. A damage 12 caused by a minor stress attack is shown to the rightmost receptor 17 which changes the intensity of the induced light flux 9 of the rightmost receptor 17. The translucent emitter 19 and translucent receptors 17 are shown without a surface coating in an embodiment that would be suited for installation in a dark place or embedded under or within an opaque material. An algorithm can detect a sudden small change in light intensity resulting from damage 12 to only the rightmost receptor 17 (as depicted) and infer a minor stress attack from the direction where the rightmost receptor 17 is located. A more severe stress attack would logically cause damage to most or all receptors.

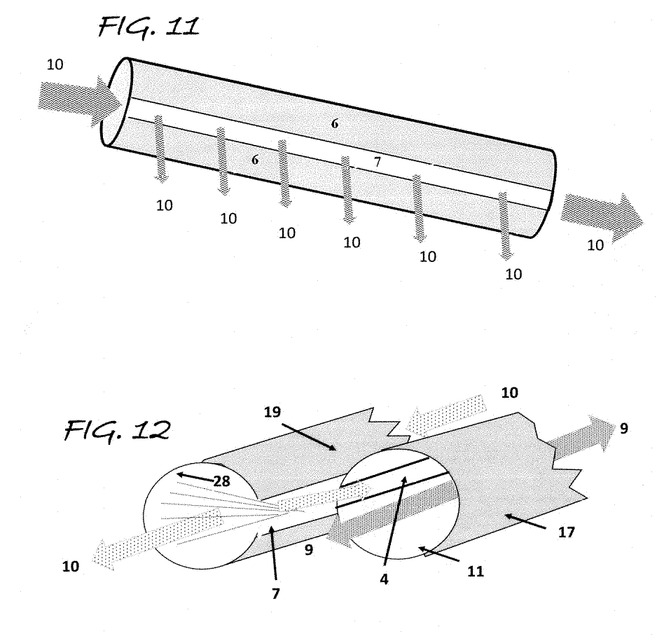

Referring now to FIG. 11, which is a perspective view of a translucent media with a side-emitting feature 7 which can be produced by applying an opaque cladding 6 in less than full circumference. This feature allows stimulating light flux 10 to flow out of the material in a radial direction along the length.

Referring now to FIG. 12, which shows diagrammatically how an emitter 19 with an inward reflecting coating 28 focuses stimulating light flux 10 axially through a side-emitting feature 7. The translucent receptor 17 has a light reflecting surface 11 to redirect the stimulating light flux 10 received axially from the emitter 19 through a side-receiving feature 4. The induced light flux 9 is guided axially within the receptor 17 in both directions.

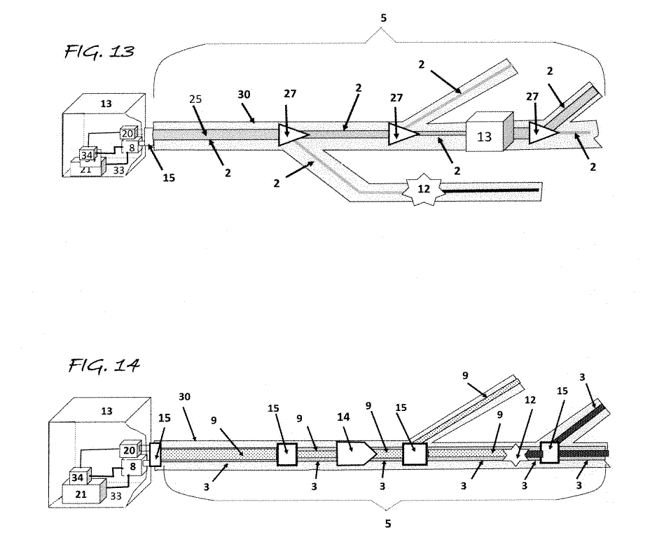

Referring now to FIG. 13, which is cutaway view of an embodiment according to the teaching herein. The branched sensor tree 5 is depicted for the purpose of monitoring for a stress attack on a branched conduit 30. The branches 2 are formed with unbroken lengths of translucent media 25 passing through the bifurcating splitters 27. A damage 12 from a stress attack is shown which could be caused by, but not limited to, heat, incision, abrasion, etc. For example, the translucent media 25 would melt at a lower temperature than a glass strand. A coating/cladding is omitted to show the interior.

Referring again to FIG. 13. On the left is an instrument 13 comprising a processor 21 operably coupled to a controller 34 that operates a photodetector 20 and a source of stimulating light 8. The instrument 13 is operably coupled to the leftmost branch 2 of the sensor tree 5 with coupling 15. The sensor body (not shown) is comprised of lengths of translucent media 25 selected for emitter or receptor properties. The contiguous translucent media 25 pass through splitters 27 at junctions forming branches 2 with receptors and emitters within each. The photodetectors 20 output signal 33 which is indicative of the intensity of induced light. Output signal 33 is operably connected to a processor 21 which is configured to monitor for change in intensity of induced light. A damage 12 is depicted that causes the intensity of induced light to change. (Note the darkened portion of the branch 2 to the right of the damage 12.) The processor 21 in the instrument 13 can be configured with a look-up table, or an inverse transform which can be Bayesian or Frequentist, or interpolation of data points obtained during calibration, or by solving equations, or other appropriate algorithm to calculate the curvilinear length to determine the location of the damage 12 caused by a stress attack. A person of ordinary skill in the art would understand the processor 21 can also be configured with an algorithm that processes the rate of change in intensity of induced light to calculate a risk of more significant damage and a potential cause of the stress attack. The processor 21 can be further configured to sense a change in the signal 33 representing intensity of light from the photodetector 20 and, on sensing a change, calculate the location of a stress attack by using a transform that maps the signal 33 to a location on a particular branch of the sensor tree 5 therefrom the location of a stress attack.

Referring again to FIG. 13, another instrument 13 is shown on the right as a different algorithm may be needed to determine the cause of the stress attack that produced the damage 12 based on factors related to, such as, but not limited to, the kind of translucent material, melting point, hardness, strength, or cladding.

Still referring to FIG. 13, each instrument 13 will be able to measure the curvilinear distance to damage 12 in the branches 2 of the sensor tree 5 coupled to the instrument 13 nearest respective branches 2. The sensor tree 5 is accomplished by using splitters 27 that separate each section of the sensor tree 5 to follow the next branch forward in the harness. Unlike with reflectometry, there will be no ambiguity as to which branch is at risk because each branch has a separate branch of the sensor tree 5.

Referring now to FIG. 14 which is a cutaway perspective view of an instrument 13 comprising a processor 21 operably coupled to a controller 34 that operates a photodetector 20 and a source of stimulating light 8. The instrument 13 is operably coupled with coupling 15 to a sensor tree 5 disposed on a branched conduit 30. The multiplicity of sensors 3 are coupled end to end. The thickness of the symbols representing induced light flux 9 depicts the intensity of the induced light flux 9.

Still referring to FIG. 14, which depicts that as length of coupled translucent media increases, the quantity of guided light diminishes due to effects such as, but not limited to, a scratched lens, as well as oil or particulate in the light path or reflections at curves, in addition to defects, impurities, and other impedances. Optical repeaters 14 are shown which maintain the quantity of light transmission should distances or operational situations require. A damage 12 caused by a stress attack is shown. The processor 21 would be configured with either a look-up table, or an inverse transform which can be Bayesian or Frequentist, or interpolation of data points obtained during calibration, or by solving equations, or other appropriate algorithm to calculate the location of a stress attack at the location of damage 12 based on the signal 33 indicative of intensity of induced light produced by the photodetector 20.

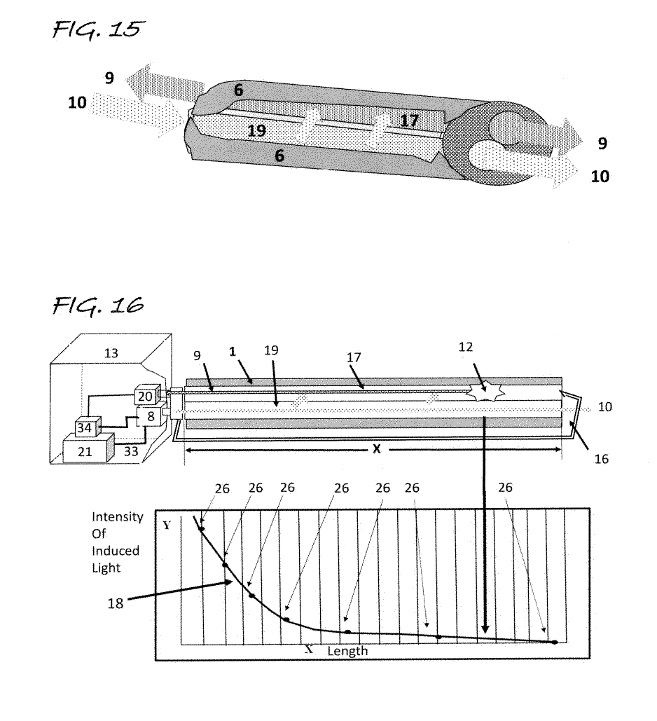

Referring now to FIG. 15 which is a cutaway drawing of an exemplary embodiment of a sensor with a translucent emitter 19 proximal and parallel to a translucent receptor 17 sheathed within an opaque cladding 6. Stimulating light flux 10 enters the emitter 19 and a portion radiates axially into the receptor 17. Induced light flux 9 is guided bi-directionally within the receptor 17.

Referring now to FIG. 16 which is a cutaway view of an exemplary embodiment of the current invention. On the left is an instrument 13 comprising a processor 21 operably coupled to a controller 34 that operates a photodetector 20 and a source of stimulating light 8. The photodetector 20 receives light from the left end of receptor 17. The source of stimulating light 8 is operably coupled to the left end of emitter 19. A mounting surface 16 is shown beneath conduit 1.

Still referring to FIG. 16, stimulating light flux 10 travels the length of emitter 19 and a portion is emitted radially that enters substantially all of the length of receptor 17 causing induced light flux 9 at a different wavelength which is guided axially to photodetector 20. It is noted that it is inherent in the Inverse Square Law of Light Intensity Versus Distance Light Travels that the intensity of the induced light flux 9 entering the photodetector 20 relates monotonically to the length of the translucent receptor 17. Further, according to the Inverse Square Law of Light Intensity Versus Distance, the intensity of induced light flux 9 that exits the end of receptor 17 into photodetector 20 decreases monotonically as length of receptor 17 increases. The graph 18 plots length X versus light intensity Y measured by the photodetector 20. Hence, when damage 12 of a stress attack shortens the receptor 17, the intensity of induced light flux 9 received from the end of the receptor 17 coupled to the photodetector 20 increases and the magnitude of the signal output by photodetector 20 increases.

Still referring to FIG. 16, processor 21 may be a dedicated microprocessor or a general-purpose computer, and may be configured to calculate the desired distance X to the location of the damage 12 by using a look-up table, or an inverse transform which can be a look-up table, or an inverse transform, which can be Bayesian or Frequentist, or interpolation of data points 26 obtained during calibration, or by solving equations, or other appropriate algorithm. Additionally, processor 21 can be configured to process the rate of change in the difference in intensity to calculate the risk of a significant damage to the conduit 1 and also prognose a future damage which could endanger life or property. Also, processor 21 converts the signal 33 output by photodetector 20 (e.g., a photodiode) into the desired length measurement X by using a look-up table, or an inverse transform (which can be Bayesian or Frequentist), or interpolation of data points 26 obtained during calibration, or by solving equations, or other appropriate algorithm. For some applications such as pipelines there can be a need for multiple instances of instruments 13 each with a photodetector 20 coupled at a first end of a receptor 17 as means to measure intensity of the induced light emission at the first end.

Still referring to FIG. 16, instrument 13, including a processor 21 and associated electronics. The source of stimulating light 8 couples to an emitter 19 which emits stimulating light flux 10 axially. The stimulating light flux 10 causes induced light flux 9 in a proximal and parallel receptor 17. A photodetector 20 produces a signal 33 indicative of the intensity of induce light flux exiting from the translucent receptor 17.

Referring still to FIG. 16 a point of damage 12 reduces the original length of the receptor 17. The processor 21 receives the light intensity signal 33 from the photodetector 20 and calculates the desired length (or position of damage) measurement X by using an inverse function, a look-up table, interpolation of a calibration data, or by solving equations, as appropriate.

Referring again to FIG. 16. The curve shown in the graph 18 fits tuples of data points 26 collected during calibration testing. Wherein Y is magnitude of the signal output by photodetector 20 caused by the intensity of light from the receptor 17 collected during calibration testing and induced by light from the emitter 19. In the graph 18, X is the length of the receptor 17 that produced the intensity of induced light Y. The length X to the damage 12 can also be produced by a look-up table, or an inverse transform which can be Bayesian or Frequentist, or interpolation of data points 26 obtained during calibration, or by solving equations, or other appropriate algorithm.

Referring still to FIG. 16, an example of a calibration method of measuring a length X along a one-dimensional curvilinear, coordinate system X using instrument 13 may comprise the following steps:
f) providing a multiplicity of translucent emitters 19 with a length X, a first end, and a second end;
g) providing a multiplicity of receptors 17 oriented pairwise substantially parallel and proximal to one or more of the emitters 19;
h) providing a source of stimulating light 8 coupled to the first end of the light emitters 19;
i) providing a photodetector 20 that is optically coupled to the first end of the light receptor 17 for providing a signal 33 indicative of the intensity of induced light from the receptors 17;
j) calculating the desired length measurement X by analyzing a signal, outputted by the first photodetector 20 with a look-up table, or an inverse transform which can be Bayesian or Frequentist, or interpolation of data points 26 obtained during calibration, or by solving equations, or other appropriate algorithm.

Referring again to FIG. 16, a person familiar with automated measurements would appreciate the monotonicity of the graph 18. Further, that complex bending of an optical sensor will have little or no effect on the calculation of the length X. Further, a person familiar with creating photonic sensors would appreciate that the straight construction of the sensor in FIG. 16 is the maximum extension and a curved sensor will produce the same X as that produced by a straight sensor.

### DETAILED DESCRIPTION OF THE INVENTION

The following is a detailed description of exemplary embodiments to illustrate the construction of an apparatus, sensor, and method which provide the ability to sense a stress attack at a location along a conduit.

Several embodiments are provided to illustrate aspects of the invention, but the invention is not limited to any embodiment. The scope of the invention encompasses numerous alternatives, modifications, and equivalent; it is limited only by the claims.

One embodiment involves simple sensors comprised of an emitter and a receptor coupled to an instrument that senses change in light intensity to detect damage caused by a stress attack.

Another embodiment uses two or more sensors disposed vertically so that a first sensor is damaged before the second one and so on. The time to damage each sensor provides information on the rate of stress and damage.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The purpose of the sensors, which are comprised of lengths of translucent media, is to collect light that is coupled to a photodetector that provides intensity of light data for measuring the curvilinear distance to damage on continuous or multi-branched conduits with an inverse transform. The magnitude of the signal outputted by photodetector depends in a monotonic and continuous fashion on the intensity of guided light induced within the receptor by the stimulating light of the emitter, which, in turn, depends in a similar fashion on the intensity of the induced light that illuminates the photodetector.

According to the present invention the sensors can be constructed with a multiplicity of heterogeneous discrete lengths of translucent media that is naturally sensitive, or specifically made to be sensitive to stressors or the damage caused thereby, with a substance specific to a class of anticipated stressor or anticipated damage caused by stressors; and,

A substrate, matrix, mesh, substance, or surface which forms or encases said the translucent strands in a measurable pattern; and,

At least one electronic processing device of a type called an automated controller, or an interface to another suitable processor with ability to digitize, process, and perform pre-stored algorithms of calculus and logic; control a device that sends light into the said strands; and receive data from a light measurement means; and,

At least one receptor means for collecting light emissions from proximal light source means wherein the intensity of the collected light when measured at one end of the receptor relates monotonically to the length of said at least one receptor; and,

At least one source of ultraviolet or other stimulating light flux for the purpose of illuminating the number of emitter strands that are able be excited.

The apparatus comprised of light sources emitters, receptors, photodetectors, and controllers serves as a means for achieving the objectives of the present patent, which include, but are not limited to, sensing, detecting, locating, measuring, and messaging about stressors and imminent or actual damage to, or deterioration of, objects in immediate proximity.

In accordance with the present invention, elongated translucent substances are used to build the sensor that provides data that is used by an algorithm, which produces a measure of the length of the sensor.

In accordance with the present invention, altered length of a receptor in a sensor infers actual or potential damage to proximal objects.

In accordance with the present invention, receptors are translucent with a side-emitting property so that sensors internal to a sensor either receive or emit light into each other.

In accordance with the present invention, there are two types of sensors; 1) an emitter that conducts light from an external source and emits light from one or more portions of the longitudinal surface; 2) a receptor that has one or more translucent areas on the axial surface, which permit flux to enter the receptor.

In accordance with the present invention, a receptor can have a natural property or can be sensitized with a dopant that produces an intensity of induced light emission that corresponds to exposure of an intensity of one or more wavelengths of stimulating light from an emitter. In other words, the receptor emits light at a secondary wavelength when exposed to a primary stimulating wavelength. These dopants cause the sensors to fluoresce when exposed to light having the “correct” wavelength or range of wavelengths (i.e., a wavelength(s) selected to lie within the band of wavelengths that excites fluorescence). Examples of fluorescing dopants include over 80 different organic dyes that are commercially available, having fluorescent emission ranging from 370 nanometers nm) to 820 nm for use with plastic sensors; and rare-earth elements for use with glass sensors, such as neodymium or erbium, which fluoresce at about 1060 nm, in response to ultraviolet rays at about 810 nm.

In accordance with the present invention, receptors can be sensitized with aniline or other dopant that emits light at a second wavelength when exposed to a primary wavelength.

In accordance with the present invention, the sensor can be comprised of any suitable translucent media.

According to conventional design practices, the instrumentation can be constructed in an electrically isolated package, optically coupled to the optical emitter(s) and receptor(s).

The apparatus of the present invention provides a means to obtain, baseline, and learn from data; the means to learn and fuse data to probabilistically assess causal factors of damage; the means to quantify the state of deterioration and damage that has occurred; the means to assess the risk that a situation exists that likely will soon cause deterioration or damage to happen; and the means to formulate and communicate messages about the state of deterioration, damage, risks of damage and causal factors.

In accordance with the present invention, a sensor is constructed of lengths of polymer or silica sensor. Before extrusion, the polymer or silica can be doped with a chemical that produces light at a second wavelength when excited by a primary ultraviolet wavelength.

In accordance with the present invention, a layer, sleeve, or tape made of a multiplicity of said strands of media coated, doped, and otherwise sensitized to anticipated conditions within, and external to said conduits, then adding the constructed apparatus as an appliqué, sheathing, weaving, or winding to the outer or inner surface of an object such as a wiring harness or conduit.

In accordance with the present invention, ancillary electronics that are not an integral part of the apparatus (such as personal computers), signal conditioners (used for instruments not included in the apparatus) should be selected so as to be able to be readily interfaced to the apparatus.

In accordance with the present invention, the controller and other electronics should be packaged with foresight to prevent damage to itself or other entities.

In accordance with the present invention, the substrate, mesh, or surface on which optical sensors are formed, overlaid, or attached can be of any suitable material.

In accordance with the present invention, when used in communication with a commercially available computer, the calculated curvilinear distances, data, causal inferences, probabilities, and messages generated by the instrumentation of the present invention can be used by the computer to probabilistically predict future local, system, and end effects of faults and failures as well as remedial actions.

In accordance with the present invention, a sensor is constructed using polymer or silica sensors. The sensors can be joined or spliced to other optical sensors using optical repeaters to reach long distances using commercially available connectors.

The instrumentation provides the means to collect and process data obtained with algorithms to detect and probabilistically determine a stress attack and extent of damage, as well as predict future damage and the progression of effects of failures on the system monitored.

The present invention benefits from discrete sensors that provide the means to sense local configuration, usage, threat, and environmental data. Types of said discrete sensors include, but are not limited to, devices for measuring humidity and temperature and other available data. The said discrete sensors provide the means to detect deterioration and damage as well as detect factors that would affect the monitored system and the service it provides.

The said multiplicity of sensors is selected for each application primarily as a means to provide data about distance to deterioration, damage, or causal factors; and secondarily to provide a means to locate places where deterioration, damage, or threat of damage to a single conduit or branched conduit exist. In a preferred embodiment, the sensors would be laid out in a measurable pattern for detecting risk of small stressors, where the pattern of sensors should repeat a pattern in a space of less than one centimeter to avoid not sensing problems such as a projectile penetration, pinhole leak, or a small electrical arc.

The remote computer should be selected for the ability to communicate with the controllers or perhaps indirectly with a system computer that communicates with the said controller by wired or wireless means.

Collectively, the curvilinear distance measurements and other data produced by the instrumentation taught herein provide data to use with an automated artificial intelligence algorithm to make a probabilistic assessment of factors including but not limited to potential causes of a stress attack, classes of damages wrought by a stress attack, potential risks and consequences of a stress attack, and time to an unwanted event. The remote computer provides the means to communicate in real or elapsed time to persons who are at risk, who provide maintenance services, or who otherwise need to be aware of deterioration, damage, or risk thereof to the conduit and the services it provides.

### Preferred Embodiment

hi a best embodiment, there is an instrument with at least one controller coupled to a processor. The controller operates a source of stimulating light. The source of stimulating light is operably coupled to sensors constructed of one or more emitters which are lengths of translucent media located or disposed proximally along receptors which are lengths of translucent media produce induced light flux when exposed to the stimulating light. Ideally, the proximal and parallel emitters and receptors are opaquely encased to keep artificial light or daylight from entering the receptor. The emitters guide the stimulating light axially that is radiated radially into the proximal receptor(s) that accept the stimulating light. In a best embodiment each receptor is parallel and proximal to at least one emitter so as to receive along its length stimulating light that is emitted axially from at least one emitter. The stimulating light, which is at one wavelength, enters the receptor which either naturally or co-doped to produce in induced light flux at another wavelength. (Commonly known as fluorescing.) The light entering the receptor from the emitter(s) and induced light flux is guided axially by the receptor to a photodetector that: 1) outputs signal information proportional to intensity of the induced light flux; and 2) communicates the signal information to at least one controller or other processor which accepts and processes the signal information to calculate the length of the receptor with a table lookup, inverse transform, or solving of equations, etc.

Still discussing a best embodiment, a tree like pattern of sensors that are operably connected can be connected to a single instrument. If situations may arise where additional instruments are required due to the distance involved, this can be readily accomplished with a wired, light emitting, or wireless technology, such as Bluetooth. In a best embodiment, the instrument will be placed for maximum effectiveness and, if necessary, the sensors could be connected to a commercial wireless network to enable performing functions such as sensing for end-to-end continuity tests.

In a best embodiment, the sensor utilizes the principle of absorption, where a primary translucent media emits stimulating light from its surface and a proximal, substantially parallel, secondary translucent media absorbs a portion of the stimulating light at openings along its surface. This absorbed light which is at a first wavelength illuminates the secondary translucent media and induces light at different wavelength. Photodetectors tuned to measure the intensity of induced light produce a signal indicative of the intensity which is used with a mathematical transform to calculate the length, x, of the sensor. The translucent media can be of any cross section, e.g., flat media can be used with round media and vice versa.

In another exemplary embodiment, the sensor utilizes the principle of induced luminescence absorption, where one or more translucent media strands emit a stimulating light flux from along its surface. A proximal, substantially parallel, translucent media doped with a luminescent component absorbs a portion of the stimulating light flux through its surface. This absorbed stimulating light flux, in turn, induces luminescence in the doped translucent media. A photodetector measures the intensity of the luminescence emitted from an end of the doped translucent media and produces a data indicative of the intensity which is used with a lookup table, a mathematical transform, or solving equations to calculate the length, x, of the sensor. A controller or other processor is configured to sense a change in the length and, on sensing a change, calculates a location of a probable stress attack based on the length using a transform that maps the location of the stress attack to a coordinate location on the conduit which is monitored by the sensor.

In a preferred embodiment, the current method incorporates Frequentist and Bayesian models that take into account factors such as operating domain and environmental factors that might affect a sensor response. Inference algorithms are those that use prior knowledge of data and/or causal relationships to infer states from data. Said sensors will be individually selected and sited based on the specific parameters they provide in the application and operation environment of the conduit and how damage to one or more sensitized media provides evidence for determining the cause of damage.

In a best embodiment, the controller is linked by wire or wirelessly to a remote computer such as a commercially available cell phone, smartphone, tablet, laptop, or desktop computer.

All of the embodiments above offer the following advantages over present techniques. The present invention detects many damages other than chafing caused by many circumstances besides abrasion or incision. It matters not whether the conduit is operating or not operating. The present invention detects stressor attack as well as damage from stressors, because virtually any stressor can be sensed by selecting sensitized strands specific to each damaging factor of each stressor. The present invention can be implemented to operate from manual to fully automatic. The present invention can be used to protect as well as monitor systems in addition to conduits. There are applications for the invention to monitor and protect systems and components in solar arrays, electrical generators, energy storage units, aircraft propulsion systems, vehicles, aircraft, and ships.

In a real world embodiment, the sensor means could be posited, without limitation, on the surface of or within entities.

### Construction and Operation

Producing the present invention requires following the teachings herein. Selecting and procuring or making the translucent media selected for appropriate key parameters such as melting point, transparency, stiffness, bend radius, and doping is key. Creating the sensors is accomplished by, but not limited to, designing a parallel arrangement (i.e., side by side for areas where measuring length is important) of translucent strands in proximity, where strands of an emitter emit light into one or more receptors that receive the emitted light. Another aspect of constructing the system of the present patent is selecting light sources to illuminate the strands, selecting couplings, as well as optional components, such as optical switches and optical repeaters.

Another aspect of producing the present invention is to select the controller with processor means. While the controller and processor can be coupled yet separate, there are numerous small, yet powerful controllers with processors to select from that are available from companies such as, but not limited to, Avnet, Altera, Xilinx, Texas Instruments, Intel, and Microsemi. It is also important to select photodetectors biased for optimum measurement of luminosity. Another aspect is selecting or authoring algorithms and rules for execution in the controller. Bench testing a prototype with examples of stressors and different media for the translucent strands, performing tests for operability, and collecting prior data for producing inverse transforms.

The translucent or coated sensors should, if possible, be in proximal contact with the surface of the conduit. If a heat-shrinkable substrate is used, the embodiment is heated appropriately to tightly affix the embodiment to the segments of the interconnection assembly.

Calibration data obtained during bench testing can only emulate an actual operating environment. Therefore, testing in actual conditions is important to achieve reliable results by installing the system components and apparatus onto or into the actual equipment, which the system will instrument, then activate with a suitable power source and check performance against seeded conditions.

In operation, the sensors will be affected by stressors operating on them. End to end testing of the hardware and software means taught by the present invention is probably a good idea. Tests, such as reflectometry, can be used to detect damage to any sensitized media able to carry the waveforms. On detection of said damage, the processor can execute algorithms (such as an inverse transform) for distance calculation, inference of the nature of stressor attack to determine outcomes and cause of damage, as well as predict future impacts of the damage if damage is allowed to progress. Next, the results of the detection, location, and determination of cause are used to initiate or request actions that mitigate, alleviate, or remove the stressor attack or stressors that are the cause of damage as well as corrective actions to bypass, repair, or otherwise mitigate the damage. During said actions, the damage to the monitored system is repaired and damaged sections of the sensitized media used in the embodiment of the invention are replaced or repaired.

Many modifications and variations of the present invention are possible in light of the above teachings. Determination of which embodiment to employ depends on the application. The choice should be left to system engineers and experts in operating the systems to be protected. It should be therefore understood that, within the scope of the inventive concept, the invention may be practiced otherwise than as specifically claimed.

### Reduction to Practice

The following paragraphs present how we constructed the apparatus described herein and performed calibration experiments that produced data (priors) which produced a Bayesian inverse transform for calculating curvilinear distance based on the inverse square law. In a preferred embodiment, the cause and effect (causal) relationship models are Bayesian algorithms that probabilistically take into account possible stressors and the damage they inflict based on data from a set of discrete sensors and a pattern of sensitized media. Bayesian Inference algorithms use prior knowledge of data and/or causal relationships to infer states from data such as from a set of test sensors coupled end to end forming a sensor tree. Said test sensors will be individually selected and sited based on the specific parameters they provide in the application and operation environment and how stress damage affecting the sensor provides evidence for determining the cause of damage.

We constructed an array of threshold intensities by inflicting stress damage causing progressive shortening of the length sensors with a prototype apparatus built according to the teachings herein to obtain data of distance versus Intensity of induced light. We then performed experiments with the prototype and used the data to construct a look-up table, a calibration curve, and an inverse transform that mathematically maps the current light intensity to calculate the current length of the receptor.

The process steps we used to establish a Bayesian inverse transform that takes into account factors, such as operating domain and environmental factors that affect a sensor response, are: a) construct a test apparatus with a processor, ultraviolet light source, photodetector, and a sensor constructed according to the teaching of the current patent; b) conduct a first test sequence without foreshortening the sensor to obtain a record of data tuples (priors) of induced light intensity measured by the photodetector versus the length of the sensor; c) record data tuples while progressively foreshortening the test sensor; d) use the data with a commercially available software such as NETICA™ to produce the Bayesian inverse transform that computes distance versus light intensity measured by the photodetector; and e) repeat with sensor trees constructed with end to end sensors of various lengths.

Plotting the data of length and intensity of induced light established that the curvilinear length of the waveguide should show that length of the sensor is approximately proportional to the square root of the current light intensity. i.e., length=k*1.0/sqrt(current_light_intensity*y) where k and y compensate for variables, such as but not limited to, variability of the photodetector and impurities in the waveguide.

A person of ordinary skill in developing sensors would be able to produce a sensor wherein an instrument having a photodetector, a processor, a microcontroller and a source ultraviolet rays of 400 nm. The ultraviolet rays enter into one end of a length of translucent un-doped media that is tightly proximal and parallel to a translucent co-doped strand. The ultraviolet rays are conducted axially and scatter radially throughout the un-doped media. The un-doped media may be clad with a reflective substance (such as silver) except for the ends and a side emitting feature (unclad portion) which permits a portion of the ultraviolet rays to escape through the side-emitting feature into the length of translucent co-doped media. The ultraviolet rays on entering the co-doped translucent media induce luminescence at, for example, 700 nm which is guided axially to the photodetector which produces data indicative the intensity of the induced 700 nm luminescence. Data tuples of length and intensity may be collected by progressively shortening the sensor to produce lookup tables, or inverse functions, or sets of equations that map intensity to length. All this so the processor can receive intensity data and calculate the length of the sensor using the lookup table, or inverse transform, or by solving the equations. The processor can also store a coordinate topology which is used with length data to compute the location of a stress attack as taught herein.

A person of ordinary skill in developing sensors perform calibration experiments with seeded stress attacks to produce a Bayesian algorithm that not only calculates the distance to a stress attack, but also quantifies the state of deterioration and damage that has occurred; and assesses the risk that causal factors exist that likely will soon cause deterioration or damage to the conduit.

A person familiar with computing would understand that commercially available software products such as NETICA™ and MatLab™ can be used to develop the algorithms that calculate distance versus intensity of light, as well as intensity of light versus distance, that comprise the set of inverse algorithms. These and other software products provide convenient features for development of the features for complex sensor tree topologies.

In reducing the invention to practice, we acquired and used several commercially available solid and hollow coated translucent strands. We acquired commercially available translucent glass, styrene, acrylic, and polymer strands from commercial sources to use as receptors and emitters. There are literally hundreds of different commercial translucent sensor products, each with different properties. The emitter strands were selected for the property to guide the ultraviolet light axially and emit a portion of the light radially into a receptor disposed proximally along the emitter's length.

We used “deep blue” light emitting diodes which produce 400 nm (ultraviolet) rays. The LED were coupled orthogonally to emitters.

We purchased lengths of commercially available unclad glass strands that did not produce significant induced 700 angstrom light when exposed to 400 angstrom rays from the LED. We constructed receptor(s) made with single and multiple strands of approximately the same length of the emitter strands.

We also purchased commercially available co-doped unclad translucent polymer strands that exhibited an induced 700 angstrom light emission when exposed to the 400 angstrom light from the LED.

We created a sensor by disposing a 2 millimeter (mm) receptor tightly proximal and parallel to a 2 mm emitter. At one end, we connected an LED to the end of the emitter and a photodetector to the receptor. In a darkened laboratory, we observed that the light from the LED was guided axially and escaped radially along the length of the translucent emitter into the receptor. We progressively shortened the sensor and used the Excel CHART function to graph of the intensity of the induced light versus the length. We used the Excel LOGEST function to fit the data and return an array of parameters that described the inverse function. We confirmed that the data followed the inverse square law of intensity of light versus distance.

We constructed other sensors by laying emitter strands alongside receptor strands of the same diameter and length, then tightly encasing the translucent strands inside an opaque polymer tube commonly known as “shrink wrap tubing” then heated the length of the tubing with a blow dryer (see discussion of FIG. 7). As explained above, we used the Excel LOGEST function to fit the data and confirmed the data followed the inverse square law of intensity of light versus distance.

We also attached emitters and receptors of equal diameter and length in a parallel and closely proximal alignment to an adhesive tape. We focused the light from the end the receptor into a photodetector and connected the output of the photodetector to a PC-based oscilloscope. During calibration, we progressively shortened the sensor and entered data tuples of the length and intensity of the induced light flux into a Microsoft Excel spreadsheet. We plotted the data using the Excel CHART function. As described above, we used the Excel LOGEST function to generate the equation of the inverse transform that was highly correlated to the inverse square law of light and distance.

We laid other sensors of the same construction along an electrical conduit and programmed the PC-based oscilloscope to monitor for change in the photodetector data. We progressively shortened the sensor emulating a stress attack. The distance to the stress attack was accurately determined using the inverse transform.

We constructed a sensor tree with several branches joined end to end using bifurcated splitters and recorded the geometry variables. We collected baseline data, then sequentially shortened individual sensors. The distance to the point of foreshortening was accurately determined using the inverse transform.

We configured a processor the inverse transform obtained with data during calibration to determine the distance to location of a stress attack that shortened the receptor of a sensor of similar construction. We observed that the inverse transform accurately mapped the intensity of induced light measured by the photodetector to the length of the foreshortened receptor.

We conducted experiments with seeded damage. We established: a) the difference in intensity of the induced light intensity relates to a change in the length of the translucent receptor material; and b) computed distance by using an inverse transform that fitted the tuples of data comprising difference in induced light intensity measured by the detector and length of the damaged sensor to locate the seeded damage by measuring curvilinear distance along the sensor to the location of the seeded damage.

During calibration experiments, the data collected by the controller attached to the sensor was transmitted to a remote computer configured with a Bayesian inverse transform that mapped data of length and intensity of induced light emission obtained from a particular seeded damage.

We also experimented with configurations where multiple sensors were operably coupled and disposed branch-wise as a sensor tree emulating being disposed proximal to a branched conduit. The Bayesian inverse algorithm produced slightly more accurate results because it takes into account variability calculated with priors.

We also built a sensor using encapsulated hollow strands filled with a marking substance to mark points of damage caused by lacerations, erosion, corrosion, burning, arcing, and dissolution. A person with ordinary skill in the art of using hollow sensors filled with translucent ultra violet (UV) doped liquid-filled sensors would recognize that, when breached by a stressor, the liquid will leak fluid when a pressure differential occurs.

A list of references that teach how to use deterministic and Bayesian inverse transforms is provided with the present application and these references are included in their entirety by reference herein.

### CONCLUSIONS, RAMIFICATIONS, AND SCOPE

The information in this patent disclosure discloses the idea, embodiment, and operation of the invention in order to support the stated claims.

A person of ordinary skill in the art would realize the difference in intensity of the induced light emission is related to a change in the length of the translucent receptor and said person would perform calibration to obtain a mapping of tuples of light intensity and distance with a photodetector or other means at a first end of a sensor constructed according to the teaching of this patent by causing progressive shortening of the sensor at known distances from the photodetector thereby emulating damage by a stress attack to a sensor disposed proximal a conduit. Thence, compute a first transform to map tuples comprised of measured intensity at the photodetector and measured length of the translucent media and compute the inverse transform of said first transform that maps a particular measured difference in intensity of induced light emission to a particular length of the translucent media to determine a location of the stress attack. Alternatively, the distance to a potential stress attack for a particular light intensity measurement can be determined by using a look-up table, a calibration curve, or by solving the inverse transform using manual calculation or a microprocessor or a general-purpose computer.

For example, if during calibration testing, the photodetector measures intensity as 1 Watt per square centimeter (W/cm²) at a first end of a 4 meter-length of translucent media constructed in accordance with the teaching of this application, measures 4 W/cm² at 2 meters length, and measures 16 W/cm² at 1 meter length. If the photodetector measures intensity as 1.77 W/cm², the inverse transform produced in calibration will calculate the distance from the light intensity at the photodetector as 3 meters and the change in length in the translucent media as 1 meter; all from the difference in light intensity. A Bayesian inverse transform would map the empirical data (a.k.a. priors) [E=1.777 W/cm²,d-3 m], [E=4 W/cm²,d-2 m] and [E-16 W/cm²,d=1 m] and calculate the same information. I.e., the change in length of the translucent media is 1 meter and the distance from the photodetector is 3 meters.

The scope of the claims include use of patterns of diverse and different translucent sensitized media formed, laminated, extruded, glued, or taped on or in materials such as insulation and materials used to construct various types of conduits. The types of sensitized media include, but are not limited to, piezoelectric strands, coated and uncoated strands of electrically conductive materials, coated or uncoated strands of optically conductive materials, soluble strands, strands coated with base and noble metals, and materials used in waveguides and transmission lines. The various types of conduits include, but are not limited to, harnesses and cables of electrical and fiber optic systems as well as conduits comprised of pipes and hoses carrying liquids, gases, and solids.

A person of ordinary skill in utilizing processors and controllers would understand that in any embodiment, one or more additional couplings with another controller or other processor and discrete sensors can be attached to the instrumentation of the present invention at locations spaced apart from the first coupling, so that differential measurements can be taken at the couplings. The additional information from measurements at another point of the branches will accurately resolve any ambiguities caused by a plurality of sensitized media in a branched tree of conduits.

A person of ordinary skill with using sensors would understand that in the case of very long conduits (perhaps over 1,000 meters), it may be necessary to add additional instruments; probably at connectors as determined by the range of effectiveness of individual sensors.

A person of ordinary skill in the art of using translucent sensors will agree that translucent sensors are commercially available in diameters from 100 microns to three millimeters in a variety of compositions, doping, shapes and lengths.

A person with ordinary skill in conduits would understand that conduits include but are not limited to control cables, wiring, lubrication, pressurization, and fuel conduits. It is reasonable that a minimal selection of translucent media would include those to sense laceration, corrosion, heat, and chafing.

A person with ordinary skill in the art of forming pieces, strips, and strands made of translucent media will concur that, in many cases, a pattern can be embedded into potting compounds, or mounted on the surface of a solid substance.

A person with ordinary skill in the art of using sensors will understand that before installation, the sensor, or at least the translucent media of the emitter and receptor, should be surrounded by darkness or an opaque cladding for applications where the sensor might be exposed to sunlight or other stimulating light.

A person with ordinary skill in using sensors would appreciate that discrete sensors to monitor conditions such as, but not limited to, temperature, vibration, and humidity may be nice to have in some alternate embodiments.

A person with ordinary skill in the art of creating strands and their arrangement would appreciate that they can be substituted freely with equivalent components to adapt to specific application requirements.

A person with ordinary skill in the art of using controllers would appreciate and agree that various commercial equivalent controller products, or even a unique design using discrete components, can be substituted freely to adapt to specific application requirements.

A person with ordinary skill in design and use of sensors would agree that it matters not whether any translucent media is used for multiple purposes such as, but not limited to, detecting movement, tensile stress, hot spots, and vibration, because such uses are not conflicting. The said person would agree that media could be selected to collect evidence of causal factors associated with application specific environments.

A person with ordinary skill in the art of creating sensors would understand that an attachment point might be unnecessary, as proximal coupling may be possible. Also, a person with ordinary skill in the art of creating sensors would recognize that the surface and shape of the sensor can be rectangular, round, coiled, or any shape as required by the shape of entity being monitored.

A person with ordinary skill in the art of using sensors to monitor conduits would understand that the pattern of light conducting elements can be embedded or embossed on an opaque, non-light conducting substrate. Alternatively, the pattern of light conducting strands can be extruded or embossed and further, that several embedded layers can be combined with a surface layer if desired.

A person of ordinary skill in the art would understand it is possible to sequentially measure the rate of change of intensity of induced light from a sensor to calculate a risk of significant damage to the conduit and prognose a future damage to the conduit, such as a structural stress-induced leak of a conduit carrying a liquid or a fire caused by a short circuit in the case of a conduit.

A person with ordinary skill in the art of optical sensors would understand that receptors can be formulated for diverse properties such as doping the translucent media with a certain fluorescent dye.

A person with ordinary skill in the art of optical sensors would realize it is important to construct the sensor so as to endure the expected or guaranteed useful life by surrounding with surfaces that protect it from the environment, yet permit detection of the types of stressors it is intended to sense.

A person with ordinary skill in the art of using translucent materials, such as optical-grade glass or plastic sensors, would understand that mixed sensitized media can be used, such as optically-conductive sensitized media.

A person with ordinary skill in the art of photodetectors would understand that a photo-diode, photo-resistor, or photo-capacitor could be used with any selected wavelength.

A person with ordinary skill in optical measurement would understand that the accuracy of measurement is greatest when the distance between the emitter and receptor is small. It would also be understood that measurements can be made over more than one segment with reduced accuracy. It would also be understood that light can be amplified with an optical repeater so that measurements can be made over more than one segment with reduced loss of accuracy. This is consistent with the use of optical repeaters in multiple segments of conduits of long distance fiber optic systems.

A person familiar in the art of florescent illumination of doped sensors would agree that the foreshortening of a sensor doped with a fluorescing material would reduce lumens reflected to the source. The location of the point of damage is accomplished by measuring the amount of lumens sensed at the source. If the distance can be in one of several directions, a one-way optical grating can be used to limit the pass-through of the lumens to a single direction.

A person familiar in the art of optical sensors would agree that products are commercially available with an un-doped translucent core, surrounded by a translucent media doped to respond to ultraviolet rays enabling exciting the doped media with one wavelength from the core, producing induced emission of a different wavelength from the doped translucent media.

A person familiar in the art of optical sensors would agree that lengths of translucent media can be made with a translucent core doped to respond to ultraviolet rays surrounded by an un-doped translucent media that enables exciting the doped core with one wavelength from the surrounding media that produces induced emission of a different wavelength from the doped core.

A person familiar in the art of optical systems would agree that signal generators are used to produce ranges of wavelengths and intensity for fiber optic systems.

A person familiar in the art of optical systems would agree that photodetectors can measure intensity of light at selected wavelengths and a range of wavelengths.

A person familiar in the art of optical systems would agree that light will transmit axially from and absorb axially through the surface of a translucent strand unless stopped by an opaque coating.

A person familiar in the art of optical systems would agree that formulations of glass and polymers exist that change physical state (i.e., melt) at a wide range of temperatures as well as polymers that dissolve or are oxidized in a wide range of chemicals.

A person familiar in the art of using translucent sensors as sensors would agree that products are available with various types of coatings, buffers, cladding, integral gratings, integral partial mirrors, and doping.

A person familiar in the art of optical systems would agree that photodetector is a generic term for photoresistor, phototransistor, and various other devices that detect and or measure photons and intensity thereof.

A person familiar in the art of using optical strands for sensing would agree that couplings are commonly available to connect translucent strands to photodetectors and light sources.

A person familiar in the art of optical sensing would agree that beam splitters, taps, partial mirrors, and optical repeaters are commonly used.

A person familiar in the art of optical sensing would agree that products are commercially available with a core made with doped translucent media surrounded by an un-doped translucent media so stimulating light at one wavelength entering the doped core from the surrounding un-doped translucent media induces light flux of a different wavelength in the doped core.

A person familiar in the art of making sensors with translucent glass and polymers would agree that strands with opaque anodized coatings of metal and opaque polymer coatings are in wide use as well as forming light-reflecting surfaces and mirrored surfaces that improve conducting light through a translucent media.

A person familiar in the art of making sensors with translucent glass and polymers would agree that translucent strips and strands with opaque polymer coatings are in wide use.

A person familiar in the art of making sensors with glass and polymer sensors would agree that strands with anodized coatings of metal can be made with a side-emitting feature with an opening of up to or exceeding 45 degrees.

A person familiar in the art of optical sensors and sensing would agree that the shape of the strands of translucent media can be of any shape including, but not limited to, round, rectangular, square, trapezoidal, parallelograms, and oval.

A person familiar in the art of making glass and polymer sensors would agree that ribbons of combinations of glass and polymer are commercially available. Further, that such ribbons of translucent sensors can be constructed using glues, coatings, or sticky tape.

A person familiar in the art of sensors would agree that a pattern of sensors described in the current patent can touch if touching is not a source of confounding information such as caused by a metal coating of media potentially causing a metal-to-metal short or interference in a light path.

A person familiar in the art of sensors would agree that a plurality of un-doped and co-doped translucent strands with and without opaque cladding are commercially available including, but not limited to, filaments, ribbons, strips and extrusions. Further, a person familiar in the art of sensors would agree that types of translucent media are available with doped as well as co-doped cores.

A person familiar in the art of measurement would appreciate that Frequentist and Bayesian inverse transforms, as well as table look-up and solving equations, are widely used. Further, that Bayesian inverse transforms are probably the most commonly used because of available prior data from calibration testing or experience.

A person familiar in the art of stress attack mitigation, alleviation, and damage prevention would understand that the preferred configuration will result in stress attack detection with annunciation before unsafe conditions and substantial damage.

A person familiar with methods relating to monitoring, detecting, and mitigating stress attacks would appreciate that the controller could be further configured to adaptively adjust the unsafe condition criterion in response to a changed condition of the protection system or a changed configuration of a system component protected by the protection system.

A person familiar with methods relating to monitoring, detecting, and mitigating stress attacks would appreciate that a system can be configured to measure light intensity and generate a signal indicative of that measurement and subsequently take another measure to verify the unsafe condition. Further, said person would appreciate that the algorithm can produce a signal if an unsafe condition event is determined and generate an unsafe condition signal if the controller determines that the second signal is indicative of an unsafe condition event.

A person familiar with methods relating to mitigating or stopping stress attacks would appreciate that the system can include an interruption device configured to mitigate the unsafe condition in response an unsafe condition signal.

A person familiar with methods relating to detecting unsafe conditions would appreciate an input device could be configured to selectively cause the controller to determine the unsafe condition detection algorithm, verify the unsafe condition detection algorithm, or determine whether the second light signal is indicative of an unsafe condition event.

A person familiar with methods relating to detecting unsafe conditions would appreciate the unsafe condition detection algorithm could include a Bayesian algorithm to compute the probability of an unsafe condition.

A person familiar with developing methods relating to detecting unsafe conditions would appreciate the unsafe condition detection algorithm could include a comparison of the first light signature corresponding to the first light signal and a second light signature corresponding to the second light signal to detect a subsequent light altering event; the first light signal and the second light signal being indicative of a fire or arcing or other event.

A person familiar with developing methods relating to detecting unsafe conditions would appreciate the unsafe condition can be communicated, for example, to a fire department or other organization.

A person familiar with methods relating to detecting unsafe conditions would appreciate the criteria for detecting a stress attack could include one or more of a threshold value, a range of threshold values, or a predetermined light signature.

A person familiar with methods relating to sensor data collection and interpretation would appreciate that detecting change of light collected by a receptor could include one or more of a threshold value, a range of threshold values, or a predetermined light signature.

A person familiar with methods relating to sensor data collection and interpretation would appreciate that the method for identifying a precursor to stressor attack or an unsafe condition could include adjusting one or more of the precursor criteria in response to a changed condition of the protection system or a changed configuration of a system protected by the protection system.

A person familiar with sensing damage to conduits would understand that multiple sensors can be operably coupled and disposed proximal to branches of a branched conduit to uniquely determine a potential stress attack on a particular branch.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed:

1. An apparatus for measuring curvilinear length comprising:
a sensor having a first end, an opposing end, and a length X comprising:
an elongated translucent substance having a cross section less than 1 centimeter, a length approximately X; and a translucent core within having a cross section less than the cross section of the elongated translucent substance and wherein said translucent core having a natural property or a dopant that, when exposed to ultraviolet rays, produces an intensity of induced light flux that relates to the length of the sensor;
an instrument coupled to said first end comprising:
a source of ultraviolet light operably coupled to send a flux of ultraviolet rays into the elongated translucent substance,
a photodetector operably coupled to said translucent core wherein the photodetector outputs a signal indicative of the intensity of said induced light flux;
a processor configured to:
4) receive the signal proportional to the intensity of the induced light flux;
5) compute the length of the sensor; and
6) output a data indicative of the length of the sensor.

2. The apparatus of claim 1 wherein the sensor is proximal and parallel to a conduit and if the processor computes the length of the sensor as less than a previously computed length of the sensor the processor outputs a signal indicative of a location of a potential stress attack on the conduit.

3. The apparatus of claim 1 wherein the processor is configured to:
1) compute a first transform to map tuples comprised of a plurality of measured differences in intensity and a plurality of correlated measured lengths of the sensor; said tuples produced by shortening the length of the sensor at progressively lesser distances from the first end;
2) compute an inverse transform of said first transform useable to map a particular measured difference in intensity to a particular length of the sensor to determine a location of the stress attack; and
3) transmits a signal indicative of the location of the stress attack.

4. The apparatus of claim 1 wherein multiple instances of the translucent media are operably joined and disposed proximal to a branched conduit.

5. The apparatus of claim 1 wherein the translucent media is opaquely surrounded by darkness or an opaque substance.

6. The apparatus of claim 1 wherein the controller is further configured with means to calculate a rate of change in the difference in intensity and processes the rate of change and a thickness of the translucent media to calculate a risk of a significant damage to the conduit and prognose time to said significant damage.

7. An apparatus for distance measurement comprising:
a second translucent media having a primary end, a secondary end, and a length to guide a certain light flux axially and emit said certain light flux radially;
a first translucent media having a first end, a second end, and a length less than or equal to the length of the second translucent media, wherein said first translucent media produces an induced light flux when exposed to the certain light flux; and
said second translucent media disposed proximal and parallel to the first translucent media;
a sensor coupled to the first end of the first translucent media to measure a difference in intensity of the induced light flux received at the first end, the difference in intensity of the induced light flux relating to a change in the length of the first translucent media; and
a controller to operate the sensor and signal location of a stress attack based on the difference in intensity of induced light.

8. A system for determining a distance to a stress attack to a branched conduit comprising: a branched sensor tree disposed proximally and along a branched conduit; said branched sensor tree comprising a multiplicity of mutually coupled sensors, each sensor having an initial end and a terminal end, and each sensor comprising:
a first translucent media having a first end, a second end, a length x; and an intensity of induced light flux that corresponds to the first translucent media's exposure to an intensity of a certain light having photons of a range of wavelengths;
a second translucent media having an initial end, a terminal end, and a length x₀ no shorter than x disposed proximal and parallel the first translucent media;
said second translucent media conducting an intensity of the certain light axially and radially;
at least one photodetector coupled to the initial ends of said sensors to measure a difference in intensity of the induced light flux received via the first ends, wherein the difference in intensity of the induced light flux indicates a physical change in the length of the first translucent media; and
a processor configured with one or more automated algorithms that:
1) determine the length of the first translucent media based on the difference in intensity of induced light and
2) determine from the length of the first translucent media a location of a stress attack on the branched conduit.

9. The instrument of claim 8 wherein the processor is further configured with either a Frequentist or a Bayesian transform to calculate a location of a stress attack based on the signal indicative of intensity.

11. The instrument of claim 8 wherein the certain wavelengths of light include a primary ultraviolet wavelength.

12. The instrument of claim 8 wherein the processor is additionally configured to output a data representing the location of a stress attack.

13. The instrument of claim 8 wherein the processor is additionally configured with an artificial intelligence algorithm to make probabilistic assessments of factors such as but not limited to:
1) potential causes of the stress attack;
2) classes of damages wrought by the stress attack;
3) potential risks and consequences of the stress attack; and
4) time to potential unwanted event.

14. The instrument of claim 8 wherein the processor is further configured to sense a change in the signal and on sensing the change calculate the location of a stress attack based on the length of the at least one receptor using a transform that maps the signal to a location on the conduit.
